(19) United States
(12) Patent Application Publication
(10) Pub. No.: US 2012/0160151 A1
(43) Pub. Date: Jun. 28, 2012

(54) ADJUSTABLE GARAGE PARKING LOCATOR DEVICE

(76) Inventor: PATRICK BATTAGLIA, THOUSAND OAKS, CA (US)

(21) Appl. No.: 12/978,292

(22) Filed: Dec. 23, 2010

(51) Int. Cl. G12B 11/00

(52) U.S. Cl. 116/28 R

(57) ABSTRACT

An adjustable garage parking locator device is disclosed in three iterations. All iterations are distinctively unique from prior art in the device contains a vertical adjustment means that is accessible from the garage floor while the device is suspended from the ceiling. Embodiments include the ability to move the device about for adjustments to varying vehicles heights and lengths, while being designed with ease of operation and maintainability.

### FIELD OF INVENTION

This invention is in the field of driving aids whereby it assists the operator of a motor vehicle in the proper placement and location of said vehicle in relation to a desired parking locale. Said device is designed to be used and operated by a general consumer of retail items of legal driving age.

### BACKGROUND OF THE INVENTION

As today's garages are more narrowly designed in nature and one's non-vehicular impediments in the garage are increasing in number and volume, the need for exact placement of one's vehicle in a garage is becoming more critical. It is also true that carports, vehicle sheds and portable garages are gaining in popularity and people are less familiar with the newer parking locales. Particularly absent from these newer style of garages are the familiar landmarks that one usually uses to guide one's vehicle into location. It is also true that the volume of non-vehicular possessions that one finds one's garage these day reduces visual cues used to locate ones' vehicle in the garage, and it is even more difficult as the possession seem to overtake one's normal parking spot.

### DESCRIPTION OF THE RELATED PRIOR ART

People have tried many means in order to locate the proper placement of their vehicle their parking area, including lining up one's shoulder with the mark on the wall, in order to effectuate the proper placement of the vehicle albeit being in far enough in order to close the garage door. People have used a simple tennis ball held in place by string extended from the garage ceiling to indicate that one has proceed far enough into the parking spot. In fact, the hanging ball concept was patented in U.S. Pat. No. 2,854,942 issued to Ross on Oct. 7, 1958, in which he discloses a hollow ball that is suspended from the ceiling at a height of the driver's eyes, which is located so that the hollow ball will contact the windshield of the car when the driver has reached the desired spot. Though simple in design and execution, the device is very difficult to adjust and position, as one needs to somehow be located on a ladder at the ceiling over the car in the exact position and attach the ceiling mount to the ceiling while leaning over the car. Adjustability and adaptability to new cars or other cars parking in the same location is very difficult and impossible from the ground level, as one needs to un-attach and re-attach the ceiling mount for every little adjustment needed. This device does have the attribute of having the driver focusing in an object that is in the direction of the car's path, so the driver is looking forward and safely proceeding.

Another style of prior art has it's mountings on the floor of the garage. Pending application 20090031943 invented by Wang and submitted on Feb. 5, 2009 details a similar locating device but is located on the floor. It consists of a stick flexibly mounted to a base and where the other end of the stick terminates in a ball or other device. In this instance, a spring is used to provide a flexible connection to the mount. The driver is to approach the device whereby his contact with the device with the automobile is signaled by an associated movement of the stick. This requires focus on the stick and not necessarily in the direction that the car is proceeding, creating a safety issue. The invention is described as “lightweight” and “easily carried”, which can lead to misplacement, dislodgement and potentially damaging accidents. Also some people are rather sensitive with what comes in comes in contact with their automobile. Another issue with this style of invention is that the cluttered garage floor space is yet inundated with another item on it.

An improvement on the contact style of locator is disclosed in U.S. Pat. No. 3,977,354 issued to Mazurek on Aug. 31, 1976, where a contact device is located along the garage wall and extends outwardly, causing the car to strike this inclined board like paddle, which signals that the car has approached it's designated place. Though it does free up the floor from impediments and the ceiling from mounts, it creates a major impediment when the car is not in the garage to people working or cleaning the garage. It is also another device with is contacting the side of the car, which is not desirable.

Another style of garage parking device is attached to neither the floor or the ceiling. One device moves with the opening and closing of the garage door. U.S. Pat. No. 3,817,203 to Brauer issued on Jun. 18, 1974 discloses an invention where the locating ball is routed about a heavy duty ceiling mounted two-speed drum system, whereby when the rolling garage door is opened, the ball descends and when the door closes, the ball is wound up into the ceiling mount. The bulkiness of the ceiling mount would require quite a complex installation involving garage door height, car location and height of ball. Placement of this drum device would be difficult with a car in the way and unfortunately the ball is always in the down position when the door is open causing an impediment to those working in the car with the car removed. The adjustability of this device between cars of varying sizes would be difficult with a completely new installation and calculation required for each difference car.

Another concept for parking location takes advantage of non-contact visual indicators. One style of invention, such as U.S. Pat. No. 5,127,357 issued to Viskovich on Jul. 7, 1992, uses a series of mirrors to focus the taillights of the car with the driver side mirror when the car is in the proper location. Issues involving this style of device are that the focus is on the driver side mirror and not in the direction in which the car is traveling, creating a potentially disastrous situation with anything or anyone in front of the car. The obvious issues of sunlight and other reflective surfaces and light sources would seem to limit the usability of this invention, along with the simple accidental movement of the guiding mirror could lead to misalignment of the car and since the operator is not focusing on his forward progress, many other items could be at risk. Other electronic devices use contact mats to signal that the proper location has been met and proximity sensors are available to activate lights when a car is properly located in the parking space. These become expensive options, prone to accidental maladjustments and are dependent on power sources.

What is needed is a device that is easily mounted and adjustable once mounted. It would be desirable that a device be made available where one, while located on the floor level, is able to adjust the level of the device in relation to the parked the car while the car is in the desired physical location.

What is also needed for a garage parking locator device is the ability to change the position of the device horizontally while the person is on the floor without having to remove the car from the parked location.

What is also needed is for a garage parking locator device is the ability to horizontally adjust the device without having to reattach the device to the ceiling of the garage or car port.

What is desired is the ability to have a garage parking locator device that has the ability to change it's position in all 3 axes without removing the device from the ceiling of the garage and it would be most desirous to be able to change the location of this device along all 3 of it's axes while the user is located on the floor of the garage.

The invention disclosed herein combines the desired effects of a garage locator parking device without the problems and potential safety issue associated with the prior art.

### SUMMARY OF THE INVENTION

According to the desired attributes of a garage parking locator device, one can see that the prior art, both patented and non-patented, has deficiencies in their objectives, operations and functions, which can be overcome with the disclosure of this adjustable garage parking locator device. All devices are meant to accomplish the same function, to enable the operator of a motor vehicle to be able to pull into a parking location, using a visual clue in order to direct and limit the path and progress of said vehicle into the parking locations. It is to those ends that this invention functions, but it is in the unique manner of positioning, adjusting and maintaining this device where the present invention discloses unique and operationally superior means to accomplish the desired function. The invention that is herein disclosed, enables the user a variety of means of locating the device in order to accomplish a variety of locations that can be encountered while using any of such devices.

In its simplest form, the inventor discloses a garage parking locator device that has a single point of attachment on the ceiling of the garage, carport or other enclosed parking entity. A single signaling device is attached to a particular length of cord which loops through said attachment point. Prior to, and after, the looping of the cord through the attachment point, the cord passes through an adjustable thumb activated friction generating means whereby said friction generating means allows for the passage of the cords bi-directionally, adjusting the vertical attitude of the said signaling device. Said adjustable friction generating device is located at a vertical position along said cord as to facilitate it's operation from the floor of the garage next to the car to the located.

An embodiment of the invention, is further disclosed whereby said attachment point is located upon a single axis transverse rail, whereby the axis is either located parallel to, or perpendicular of, the travel direction of the vehicle. Said rail facilities the lateral adjustment of the device, so that vehicles of varying sizes can be accommodated in the same parking location. Said attachment point is located upon said rails, and can either be set using a clamping force into a specific location or can be left to be adjustable. It is found that the device does not unnecassarily move due to the closeness of the tolerances of the attachment fittings to the rail, and any contact of the signaling device by a vehicle is not sufficient to dislodge the attachment fitting from the desired location.

Another embodiment of this invention, is further disclosed whereby said transverse rail is accompanied by a second transverse rail located in an angular axis to the first rail. The second rail is slidably attached to the first rail by a pin, said pin emanating through and terminates against the opposite side of the first rail. The attachment fitting is attached to the second transverse rail enabling the user to move the device in all 3 axes of location, all being accomplished from the garage floor.

These features and embodiments will be further described in detail, and the unique advantages herein described will become evident. The accompanying drawings figures will assist in the appreciation of this invention.

### BRIEF DESCRIPTION OF THE DRAWING FIGURES

In FIG. 1, the basic premise of the invention is disclosed with a static attachment.

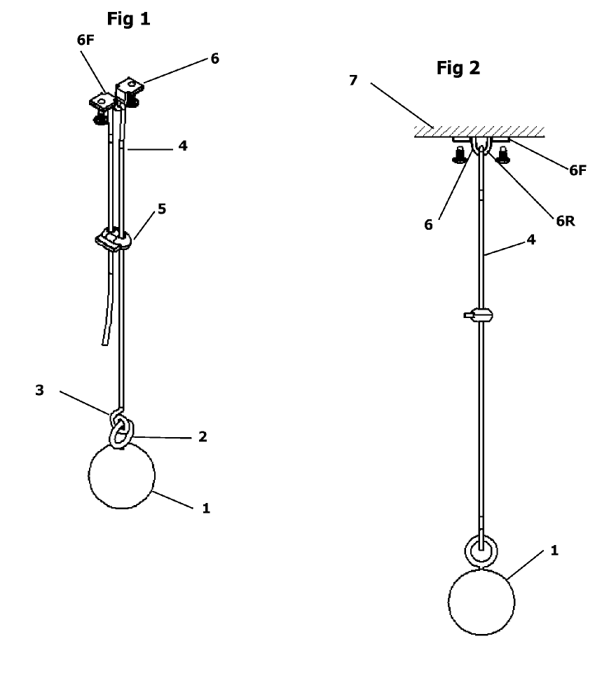

In FIG. 2, shows the embodiment of FIG. 1 attached to a ceiling or other covering under which the vehicle is located.

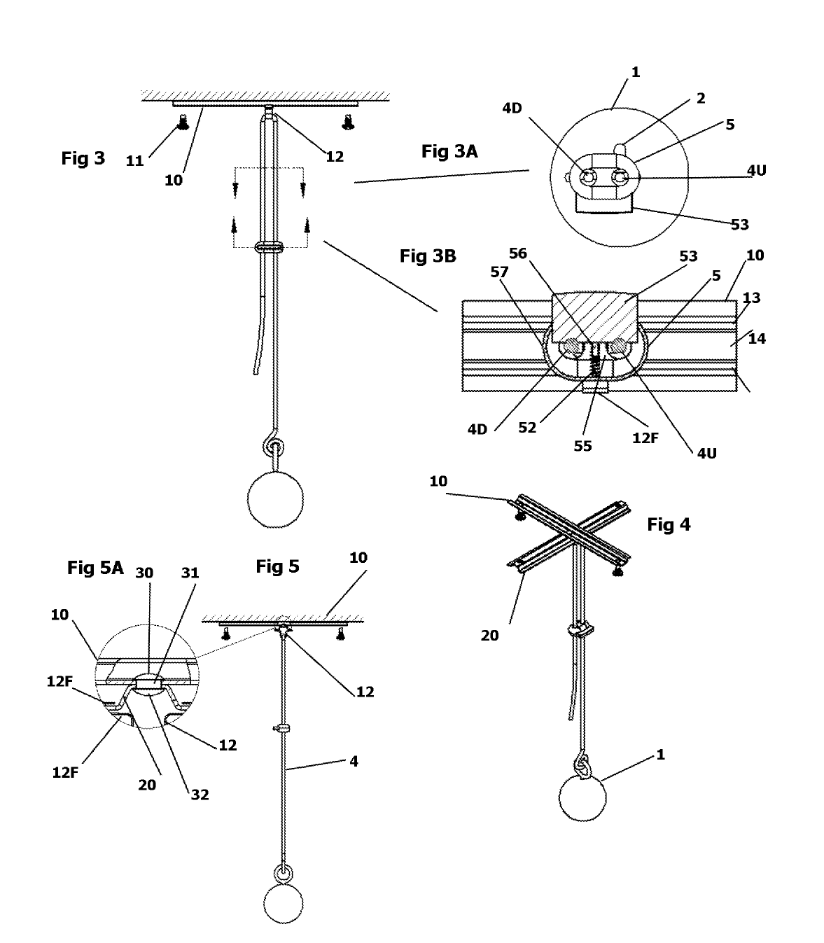

In FIG. 3, an embodiment of the invention is shown as a linear rail is attached to the ceiling. In FIG. 3A, a cross-sectional view of the height adjustment means is detailed while looking downwardly. In FIG. 3B, a cross-sectional view of the height adjustment means is detailed whilst looking upwardly.

In FIG. 4, another embodiment of the invention is shown with the addition of a perpendicular transverse rail incorporating an another axis of adjustment.

In FIG. 5, second rail 20 is removed for clarity in the main figure which is attached to the ceiling, where detail FIG. 5A examines the interrelation between the two rails and the interface means.

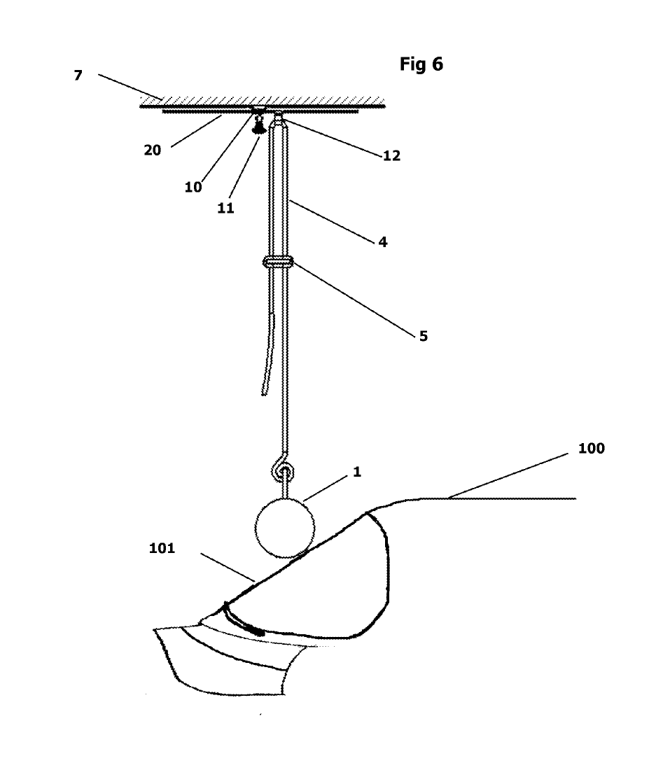

In FIG. 6, the device is shown in a working application, where the device is located above and in contact with a vehicle's front window.

### DETAILED DESCRIPTION OF THE INVENTION

In FIGS. 1 and 2, the device is shown in it's basic iteration. Signaling apparatus 1 is a pliable object capable of maintaining it's shape and rigidity and yet soft and elastic enough as not to mar a vehicle's painted body or windshield. Apparatus 1 has attached thereon a coupling mean 2 which can be rotatably affixed onto or through apparatus 1. In this invention, the means 2 is permanently affixed without the desire for rotation, but it does not preclude having that ability for certain applications. Signaling apparatus 1 can be of any size, shape or dimension, and the inventor has conceived of football shaped, basketball, tennis ball, golf ball shaped objects and has developed marketing plans based on other shapes including quart sized oil bottles, water bottles, coffee mugs and snow-flake designs. It is the flexibility of the design of apparatus 1 that makes this device marketable and the only limitation on design is that a coupling mean must on accommodated in the design. For this disclosure, the coupling means is circular ring 2 being attached to a spherical ball. Lanyard 4 is terminated at one end with a coupling interface device 3, in this invention a simple hook that has been turned back upon itself creating a coupling that is flexible and allows for movement of apparatus 1 yet the apparatus 1 rotation is not limited by the capacity of the coupling device to maintain it's coupling onto ring 2. Lanyard 4 travels upwardly from apparatus 1 through one side of vertical adjustment means 5 and continues until it reaches the attachment means 6.

Attachment means 6 has 2 separate functions. First of all, flanges 6F provide mounting surfaces that the user can apply to the ceiling 7. In this application, the inventor successfully used a strong double sided tape and has also used screws in connectors in various tests. The adhesive tape is sufficient for garage ceilings made of dry wall, wood or concrete, such as found in parking garages, or for ease of application of the device for those not mechanically inclined to use a screwdriver. The second function of means 6 is to divert the upward travel of lanyard 4 into a downward direction. This diversion through radiused section 6R is smoothed in order not to chafe lanyard 4 and to minimize any frictional effects that the diversion would create, preventing the user from adjusting the vertical component of the signaling apparatus 1.

FIG. 3 shows an embodiment to this invention whereby the single attachment means is replaced with a linear travel rail 10, which is attached to the ceiling using attachment means 11, which in this detail are screws. Double sided adhesive tape is still an option and should not be discounted for short rail lengths, but with longer rails, screws are necessary. Attachment means 12 is designed to travel along rail 10, whereby the means 12 contains the radiused portion to minimize friction on the lanyard, but now the design of flanges 12F is integral to the shape of rail 12. In this invention, flanges 12F are shaped to conform about the outside of rail 12 as detailed in FIG. 3B. It is possible means 12 could be internally confined on parallel interior rails 13 on either side of slot 14. This invention is not confined to a single means of affixing means 12 onto rail 10, whether it is along the outside edges or interior rails.

The reminder of the embodiment of the device including lanyard 4, apparatus 1 and couplings 2 and 3 are still present. This embodiment allows for the user now to have 2 axes of adjustment. Prior art does not disclose ceiling attached parking locator devices which move along a linear track. Prior art requires the arduous task of re-mount the entire device into a new set of holes, and some of the prior art devices are heavy and complex requiring a total adjust of other features simply to move the signaling device forward or backward a couple of inches. This embodiment allows the user, on the garage floor to adjust both the height of the ball and the distance from which the vehicle is to be located from, in one easy ground floor operation.

FIGS. 3A and 3B detail the inner workings of the vertical adjustment means. Means 5 has two through holes on plate 55, through which lanyard 4 passes. Hole 4U is for the lanyard which is emanating from the apparatus 1 and hole 4D accommodates the lanyard in it's downwardly direction. Plate 55 moves laterally in case 57 when the user presses on button 53, causing the spring 52 to depress releasing the frictional interference between plate 55, button 53 and lanyard 4, allowing for lanyard to transit through holes 4D and 4U. Though this is one means for accomplishing the desired ends of having the lanyard securely held in place yet being able to adjust the positioning of the means on the lanyard, this invention does not preclude the adaption or use of other such devices that accomplishes the desired ends.

FIGS. 4 and 5 detail another embodiment of the invention. In this embodiment, a second rail 20 is attached to the slot 14 of the first rail 10 by connector pin 30. In this embodiment, the user is able to have 3 axes of adjustment for the device. The vertical adjustment means 5 provides the vertical attitude, while rail 10 is affixed to the ceiling in a preferable parallel or perpendicular orientation in relation to the travel direction of the vehicle. Now rail 20 is coupled to fixed rail 10 and is capable of any degree of rotation or orientation desired. The user now has the complete range of adjustability of the device all from the floor of the garage. Connector pin 30, as detailed in FIG. 5A, is barbell shaped whereas the wide flanged ends 32 are about a narrower middle barrel which travels along slot 14 of rail 10 as well as slot 24 of rail 20. Attachment means 12 is similar in construction as previously described herein and FIG. 5A shows an exterior flange 12F wrapping about the outside edges of rail 20.

FIG. 6 shows the two rail embodiment of the invention in operation, as vehicle 100 has been maneuvered into the proper location as apparatus 1 is lightly contacting the vehicle windshield 101. Depending on the shape and contour of various vehicles height of apparatus 1 is easily adjusted through use of means 5.

The device has been described and the best mode for practicing this invention has been herein disclosed, but the scope of this invention is not defined solely by the best mode practiced. There are components that equivalently perform the functions and operations that have been disclosed along with the various products, devices and apparatuses used and revealed herein. It is the intention that the claims will cover both the best mode as well as the spirit of this invention

What is claimed is:

1. An adjustable parking locator device to assist one in bringing to a stop a vehicle in the proper position having a fixed point of attachment comprising of,
an attachment means thereby affixed to an upper surface located above the height of the vehicle,
a signaling apparatus, upon contact with, the operator confirms that the vehicle has achieved the proper position, said signaling apparatus having a coupling means,
a vertical adjustment means, and
a lanyard which is coupled to said signaling apparatus and where said lanyard communicates bi-directionally through said vertical adjustment means, said lanyard apexing at said attachment means and progresses downwardly at a length accessible to one in standing position.

2. An adjustable parking locator device as in claim 1 where said attachment means consists of two parts, where one part consists of a radiused surface through which said lanyard is able to be transported thereover with minimal frictional interference and the second part consists of an affixing mean which is capable of removably attaching said radiused surface to said upper surface, said affixing members being capable of maintaining it's position on said upper surface withstanding the weight of said device and occasional torquing moments as device is adjusted or moved.

3. An adjustable parking locator device as in claim 2 where said affixing means are selected from a group consisting of, double-backed adhesive tape, screws, nails and bolts.

4. An adjustable parking locator device as in claim 1 where said vertical adjustment means consists of a frictional interface interfering with the travel of said lanyard therethrough, said frictional interference being sufficient to withstand the weight of said signaling apparatus, said means having the capability to relieve said frictional interference to allow said lanyard to transit through said means.

5. An adjustable parking locator device to assist one in bringing to a stop a vehicle in the proper position having a linear adjustable point of attachment comprising of,
a linear travel rail, said rail affixed to an upper surface located above the height of the vehicle,
an attachment means, capable of transiting along said rail,
a signaling apparatus, upon contact with, the operator confirms that the vehicle has achieved the proper position, said signaling apparatus having a coupling means,
a vertical adjustment means, and
a lanyard which is coupled to said signaling apparatus and where said lanyard communicates bi-directionally through said vertical adjustment means, said lanyard apexing at said attachment means and progresses downwardly at a length accessible to one in standing position.

6. An adjustable parking locator device as in claim 5 where said attachment means consists of two parts, where one part consists of a radiused surface through which said lanyard is able to be transported thereover with minimal frictional interference and the second part consists of a set of flanges, said flanges formed to interface with said rail and said radiused surface, said flanges toleranced so as to allow linear travel along said rail with minimal lateral force exerted by user while standing on the floor.

7. An adjustable parking locator device as in claim 5 where said vertical adjustment means consists of a frictional interface interfering with the travel of said lanyard therethrough, said frictional interference being sufficient to withstand the weight of said signaling apparatus, said means having the capability to relieve said frictional interference to allow said lanyard to transit through said means.

8. An adjustable parking locator device to assist one in bringing to a stop a vehicle in the proper position having multiple axes of linear adjustment and attachment comprising of,
a first linear travel rail, said rail affixed to an upper surface located above the height of the vehicle,
a second linear travel raid, said second rail being rotatably coupled to said first travel rail,
an rail interface means communicating said second rail to said first rail,
an attachment means, capable of transiting along said second rail,
a signaling apparatus, upon contact with, the operator confirms that the vehicle has achieved the proper position, said signaling apparatus having a coupling means,
a vertical adjustment means, and
a lanyard which is coupled to said signaling apparatus and where said lanyard communicates bi-directionally through said vertical adjustment means, said lanyard apexing at said attachment means and progresses downwardly at a length accessible to one in standing position.

9. An adjustable parking locator device as in claim 8 where said attachment means consists of two parts, where one part consists of a radiused surface through which said lanyard is able to be transported thereover with minimal frictional interference and the second part consists of a set of flanges, said flanges formed to interface with said second rail and said radiused surface, said flanges toleranced so as to allow linear travel along said second rail with minimal lateral force exerted by user while standing on the floor.

10. An adjustable parking locator device as in claim 8 where said vertical adjustment means consists of a frictional interface interfering with the travel of said lanyard therethrough, said frictional interference being sufficient to withstand the weight of said signaling apparatus, said means having the capability to relieve said frictional interference to allow said lanyard to transit through said means.

11. An adjustable parking locator device as in claim 8 where said rail interface means allows for said second rail to move with a set amount of friction along the linear distance of said first rail while said second rail is capable of rotating thereabout said interface means, said set amount of friction being sufficient to prevent accidental dislodgement of said signal device while allowing user at the floor level to physically adjust the location of said signaling apparatus.
